(19) United States
(12) Patent Application Publication
(10) Pub. No.: US 2025/0334772 A1
(43) Pub. Date: Oct. 30, 2025

(54) ZOOM LENS ASSEMBLY

(71) Applicant: ZHONGSHAN UNION OPTECH RESEARCH INSTITUTE CO., LTD., Zhongshan (CN)

(72) Inventors: Junqiang GONG, Zhongshan (CN); Meijiao ZHAO, Zhongshan (CN); Kun LI, Zhongshan (CN); Shengping QIU, Zhongshan (CN)

(73) Assignee: ZHONGSHAN UNION OPTECH RESEARCH INSTITUTE CO., LTD., Zhongshan (CN)

(21) Appl. No.: 18/648,942

(22) Filed: Apr. 29, 2024

(51) Int. Cl. G02B 7/10

(52) U.S. Cl. CPC G02B 7/102

(57) ABSTRACT

Disclosed is a zoom lens assembly including a fixed barrel, a moving group, a magnetic drive mechanism, a position detection device and a circuit board assembly. The magnetic drive mechanism is configured to drive the moving group to move forward and backward. The position detection device includes a detection part and a sensing part, one of the detection part and the sensing part is fixed to the fixed barrel, the other of the detection part and the sensing part is fixed to the moving group. The circuit board assembly includes a flexible printed circuit board (FPC board) and a support board. The first side surface of the FPC board is provided with a printed circuit, the second side surface of the FPC board is provided with the support board. The detection part is provided at a first side of the FPC board and a position corresponding to the support board.

### TECHNICAL FIELD

The present application relates to the technical field of variable security, and in particular to a zoom lens assembly.

### BACKGROUND

With the rapid development of high and new technologies, security optical zoom lenses have been widely used, and stepper motors are widely used in the automatic zooming and focusing of optical zoom lenses. The existing stepper motor driving method uses open-loop control, which can only sense one position by PI, has low control accuracy, is prone to loud noise, has high energy consumption, is prone to wear, loss of synchronization and other unstable phenomena, and cannot meet the increasingly stringent requirements of today's customers.

### SUMMARY

In order to solve the above technical problems, the present application considers adopting a magnetic drive method and adopting a position detection device that can realize closed-loop detection, thus detecting the moving position of the moving group in real time, enabling the moving group to quickly and accurately locate. However, in the position detection device, the detection part and the sensing part, which move relatively and induct mutually, need to be connected to the electronic control device to achieve real-time feedback of position information. How to provide a connection method with a simple structure and reliable assembly without affecting the accuracy of position detection is a further problem faced by the present application.

In order to achieve the above object, the present application proposes a zoom lens assembly, including:
a fixed barrel extending along a front and rear direction;
a moving group configured for installing lens and movably provided in the fixed barrel along the front and rear direction;
a magnetic drive mechanism configured to drive the moving group to move forward and backward, where the magnetic drive mechanism includes a drive coil and a magnetic body structure; one of the fixed barrel and the moving group is provided with the drive coil, and the other of the fixed barrel and the moving group is provided with the magnetic body structure; the drive coil is provided in a magnetic field where the magnetic body structure is located, and is configured to generate electromagnetic driving force with the magnetic body structure when the drive coil is energized;
a position detection device configured to detect a relative position of the moving group and the fixed barrel in real time, where the position detection device includes a detection part and a sensing part; one of the detection part and the sensing part is fixed to the fixed barrel, and the other of the detection part and the sensing part is fixed to the moving group; and
a circuit board assembly including a flexible printed circuit board (FPC board for short) and a support board, where the FPC board is provided with a first side surface and a second side surface provided oppositely; the first side surface of the FPC board is provided with a printed circuit, and the second side surface of the FPC board is provided with the support board; the detection part is provided at a first side of the FPC board and a position corresponding to the support board, and the detection part is provided toward the sensing part.

In an embodiment, the sensing part is provided at the moving group, and the detection part is provided at the fixed barrel;
the FPC board is provided at an outside of the fixed barrel, and the FPC board is provided to be bent; the FPC board is provided with a first main body part connected to the fixed barrel, and a first folded part folded from the first main body part toward a side of the first main body part; a side of the first main body part provided with the printed circuit is provided away from the fixed barrel, so as to cause a side of the first folded part provided with the printed circuit to be provided toward the fixed barrel; and
the support board is provided at a side of the first folded part away from the fixed barrel, and the detection portion is provided at a side of the first folded part facing the fixed barrel.

In an embodiment, the first main body part is connected to the fixed barrel, the first folded part is provided to be folded toward a side of the first main body part away from the fixed barrel, and the first main body part is at least partially protruded laterally from the first folded part; and
the first folded part is provided to be at least partially protruded from the first main body, and the detection portion is provided to be installed at a zone of the first folded part protruding from the first main body part.

In an embodiment, the first main body part is provided around a periphery of the fixed barrel, and the first folded part is provided to be folded toward a side of the first main body part facing the fixed barrel.

In an embodiment, the fixed barrel is provided with a first connection hole, both the support board and the first folded part are penetrated and provided with first via holes provided oppositely, and the FPC board and the fixed barrel are fixed by a connecting piece passed through the two first via holes and connected to the first connection hole.

In an embodiment, the fixed barrel is provided with a first connection hole, and the support board is provided to be at least partially protruded laterally from the first folded part; a part of the support board protruding from the first folded part is penetrated and provided with a second via hole, and the FPC board and the fixed barrel are fixed by a connecting piece passed through the second via hole and connected to the first connection hole.

In an embodiment, the detection part is provided at the moving group, and the sensing part is provided at the fixed barrel; and
a first side of the FPC board is provided away from the moving group, and the detection part is provided toward the sensing part.

In an embodiment, the FPC board includes a second main body part and a second folded part folded from the second main body part toward a side of the second main body part, the second main body part is provided at an end surface of the moving group, and the second folded part is provided at a periphery of a peripheral side part of the moving group; and
the support board is provided at a side of the second folded part facing the fixed barrel, and the detection part is provided at a side of the second folded part away from the fixed barrel.

In an embodiment, a first slot is provided on the peripheral side part of the moving group, and the support board and the second folded part are clamped in the first slot; and/or
the moving group is further provided with a clamping arm spaced from the end surface of the moving group, and a second slot for clamping the second main body part is formed between the clamping arm and the moving group.

In an embodiment, a positioning column is further protruded from the moving group, the second main body part is provided with a positioning hole, and the second main body part is positioned at the moving group by the positioning hole passing through the positioning column; and/or
the moving group is provided with a second connection hole, the second main body part is penetrated and provided with a third via hole, and the FPC board and the moving group are fixed by a connecting piece passed through the third via hole and connected to the second connection hole.

In the technical solution provided by the present application, the movement of the moving group is driven by the electromagnetic driving force generated by the magnetic drive mechanism, and the position detection device adopts closed-loop control and can detect the position of the moving group in real time during the movement of the moving group along the front and rear direction. The control device adjusts the position of the moving group in real time according to the displacement difference between the actual position of the lens group and the target position of the lens group. Moreover, the magnetic drive mechanism does not have problems with the physical accuracy and wear accuracy of its own products. When the magnetic drive mechanism drives the moving group to move at high speed, it is not affected by poor stopping accuracy, so that the moving group can accurately reach the target position required for zooming or focusing. Since the position detection device includes a detection part and a sensing part, one of the detection part and the sensing part is fixed to the fixed barrel, and the other of the detection part and the sensing part is fixed to the moving group. During the movement of the moving group relative to the fixed barrel, one end of the FPC board is connected to the detection part, and the other end of the FPC board is configured to connect to the control device, thus enabling the information detected by the detection part to be fed back in time and receiving control instructions of the control device in time. When the detection part is provided on the moving group, the FPC board can adaptively deform as the position of the moving group changes, and the detection part is provided toward the sensing part, so that the detection part can be as close as possible to the sensing part to achieve accurate measurement. Since the flexible base material of the FPC board will deform, in order to ensure the flatness of the detection part when it is installed on the FPC board, so that the detection part can be completely attached to the FPC board. The support board is provided on the second side surface of the FPC board, and the support board can support the FPC board and ensure the flatness of the FPC board, so as to provide a simple structure and reliable connection method, and ensure that the accuracy of position detection is not affected.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below.

Obviously, the accompanying drawings in the following description are only some embodiments of the present application, other accompanying drawings can be obtained based on the provided accompanying drawings without exerting creative efforts for those skilled in the art.

FIG. 1 is a three-dimensional schematic view of a zoom lens assembly according to an embodiment of present application.

FIG. 2 is a three-dimensional schematic view of the partial structure of the zoom lens assembly in FIG. 1.

FIG. 3 is a three-dimensional schematic view of an embodiment of the moving group equipped with the position detection device and the circuit board assembly in FIG. 1.

FIG. 4 is a three-dimensional schematic view of the first embodiment of the circuit board assembly in FIG. 3.

FIG. 5 is a three-dimensional schematic view of another embodiment of the moving group equipped with the position detection device and the circuit board assembly in FIG. 1.

FIG. 6 is a three-dimensional schematic view of the second embodiment of the circuit board assembly in FIG. 5.

FIG. 7 is a two-dimensional schematic view of another embodiment of the partial structure of the zoom lens assembly in FIG. 1.

FIG. 8 is a three-dimensional schematic view of the third embodiment of the circuit board assembly in FIG. 7.

FIG. 9 is a three-dimensional schematic view of the fourth embodiment of the circuit board assembly in FIG. 7.

FIG. 10 is a two-dimensional schematic view of another embodiment of the partial structure of the zoom lens assembly in FIG. 1.

FIG. 11 is a three-dimensional schematic view of the moving group and circuit board assembly in FIG. 10.

FIG. 12 is a three-dimensional schematic view of the moving group, circuit board assembly and position detection device in FIG. 10.

FIG. 13 is a three-dimensional schematic view of the fifth embodiment of the circuit board assembly in FIG. 10.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that if there are directional instructions (such as up, down, left, right, front, back or the like) involved in the embodiments of the present application, the directional indications are only used to explain the relative positional relationship, movement and so on between various components in a specific posture (as shown in the accompanying drawings). If the specific posture changes, the directional indication will also change accordingly.

In addition, if there are descriptions involving “first”, “second” or the like in the embodiments of the present application, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the meaning of “and/or” appearing in the entire text includes three parallel solutions, taking “A and/or B” as an example, it includes solution A, or solution B, or a solution that satisfies both A and B at the same time. In addition, the technical solutions of various embodiments can be combined with each other, but it is based on that those skilled in the art can realize. When the combination of technical solutions is contradictory or cannot be realized, it should be considered that such combination of technical solutions does not exist and is not within the protection scope claimed by the present application.

With the rapid development of high and new technologies, security optical zoom lenses have been widely used, and stepper motors are widely used in the automatic zooming and focusing of optical zoom lenses. The existing stepper motor driving method uses open-loop control, which can only sense one position by PI, has low control accuracy, is prone to loud noise, has high energy consumption, is prone to wear, loss of synchronization and other unstable phenomena, and cannot meet the increasingly stringent requirements of today's customers.

In order to solve the above technical problems, the present application considers adopting a magnetic drive method and adopting a position detection device that can realize closed-loop detection, thus detecting the moving position of the moving group in real time, enabling the moving group to quickly and accurately locate. However, in the position detection device, the detection part and the sensing part, which move relatively and induct mutually, need to be connected to the electronic control device to achieve real-time feedback of position information. How to provide a connection method with a simple structure and reliable assembly without affecting the accuracy of position detection is a further problem faced by the present application.

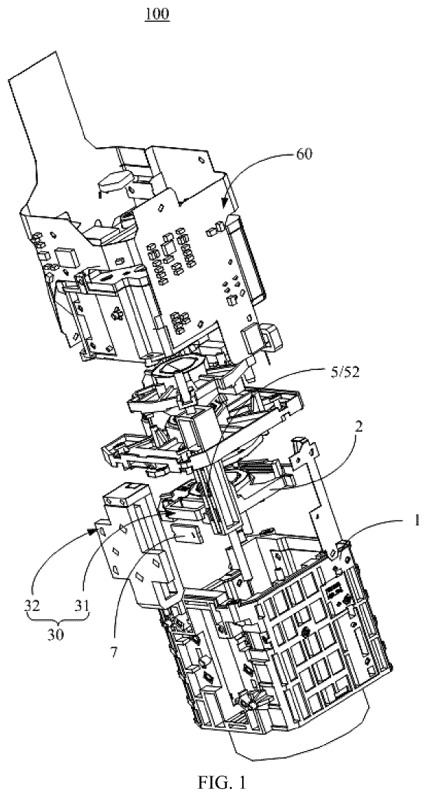

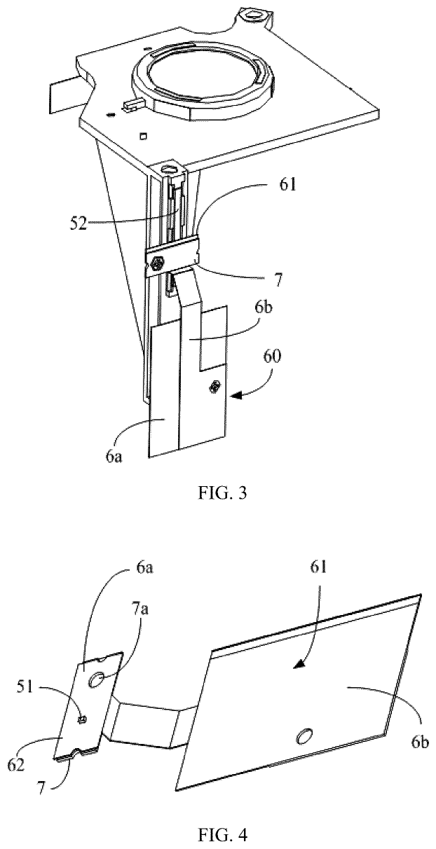

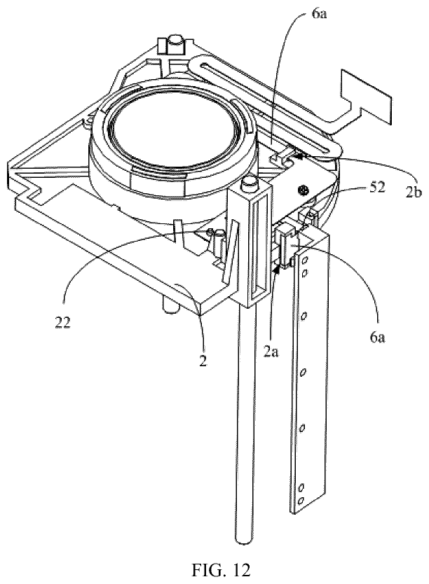

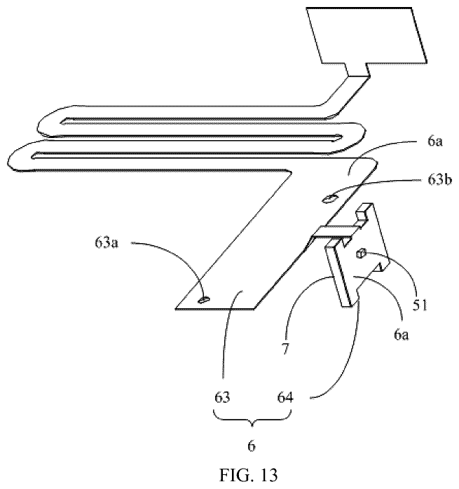

In order to solve the above problems, the present application provides a zoom lens assembly, and FIG. 1 to FIG. 13 are specific embodiments of the zoom lens assembly provided by the present application.

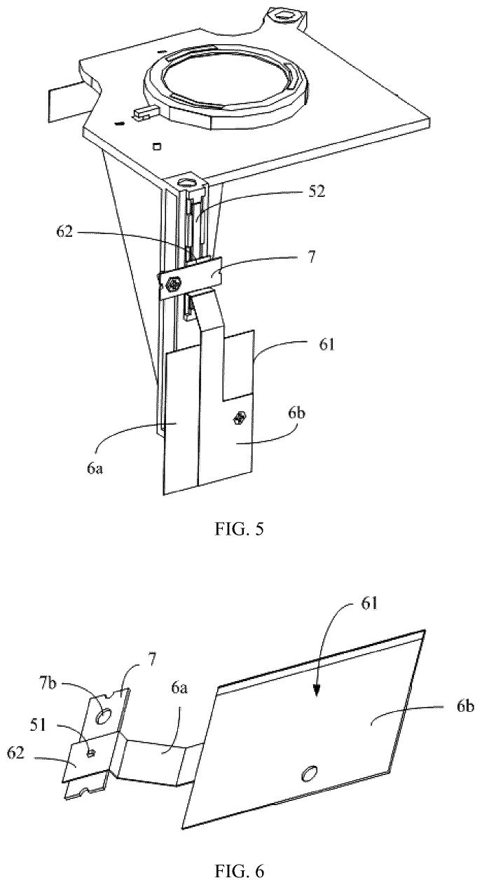

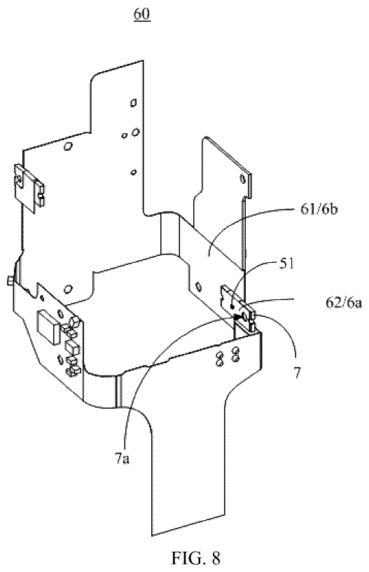

As shown in FIG. 1 to FIG. 4, FIG. 6, and FIG. 8 to FIG. 10, the zoom lens assembly 100 includes a fixed barrel 1, a moving group 2, a magnetic drive mechanism 30, a position detection device 5 and a circuit board assembly 60. The fixed barrel 1 extends along a front and rear direction. The moving group 2 is configured for installing lens and is movably provided in the fixed barrel 1 along the front and rear direction. The magnetic drive mechanism 30 is configured to drive the moving group 2 to move forward and backward. The magnetic drive mechanism 30 includes a drive coil 31 and a magnetic body structure 32, one of the fixed barrel 1 and the moving group 2 is provided with the drive coil 31, and the other of the fixed barrel 1 and the moving group 2 is provided with the magnetic body structure 32. The drive coil 31 is provided in a magnetic field where the magnetic body structure 32 is located, and is configured to generate electromagnetic driving force with the magnetic body structure 32 when the drive coil 31 is energized. The position detection device 5 is configured to detect a relative position of the moving group 2 and the fixed barrel 1 in real time. The position detection device 5 includes a detection part 51 and a sensing part 52, one of the detection part 51 and the sensing part 52 is fixed to the fixed barrel 1, and the other of the detection part 51 and the sensing part 52 is fixed to the moving group 2. The circuit board assembly 60 includes a flexible printed circuit board (FPC board for short) and a support board 7. The FPC board is provided with a first side surface 6a and a second side surface 6b provided oppositely, the first side surface 6a of the FPC board is provided with a printed circuit, and the second side surface 6b of the FPC board is provided with the support board 7. The detection part 51 is provided at a first side of the FPC board and a position corresponding to the support board 7, and the detection part 51 is provided toward the sensing part 52.

It should be noted that due to the closed-loop real-time feedback of position information based on the position detection device 5, high-speed drive control can be performed by the magnetic drive mechanism 30. While increasing the speed, using PID (Proportional Integral Derivative) to balance the real-time position. The position detection device 5 can detect the position deviation of the magnetic drive mechanism 30 in time, control the magnetic drive mechanism 30 by the control device in time to continue working, and adjust the position of the moving group 2, which can effectively increase the zoom speed/focus speed of the moving group 2.

It should also be noted that based on the above closed-loop control, since the position detection device 5 can feedback position information in real time, even if there is a momentary inaccuracy in the magnetic drive mechanism 30, the moving group 2 can reach the designated target position by the PID control algorithm.

It can be understood that when the detection part 51 is provided in the moving group 2, when it is necessary to connect the detection part 51 to the control device, adopting soft FPC board can realize circuit connection and adaptive deformation occurring with the position adjustment of the moving group 2. Because the circuit design in the zoom lens system is relatively simple and the cost of a single-sided board is low, when the corresponding space is extremely limited, the FPC board can adopt a single-sided board instead of a double-sided board. That is, in a FPC of single-sided board, the circuit exists only on one side of the flexible base material; while in FPC of double-sided board, the circuit exists on both sides of the flexible base material.

In this way, when the detection part 51 is provided at the FPC board, the detection part 51 needs to be provided at the side provided with the printed circuit. Moreover, in the position detection device 5, in order to avoid electromagnetic interference and magnetic field interference, and the excessive distance between the detection part 51 and the sensing part 52 may affect the accuracy of signal transmission and detection. When arranging the detection part 51 and the sensing part 52, the distance between the detection part 51 and the sensing part 52 needs to be provided relatively close, and the orientation between the detection part 51 and the sensing part 52 needs to be provided oppositely, so that the detection part 51 can fully interact with the sensing part 52.

In the technical solution provided by the present application, the movement of the moving group 2 is driven by the electromagnetic driving force generated by the magnetic drive mechanism 30, the position detection device 5 adopts closed-loop control and can detect the position of the moving group 2 in real time during the movement of the moving group 2 along the front and rear direction. The control device adjusts the position of the moving group 2 in real time according to the displacement difference between the actual position of the lens group and the target position of the lens group. Moreover, the magnetic drive mechanism 30 does not have problems with the physical accuracy and wear accuracy of its own products, when the magnetic drive mechanism 30 drives the moving group 2 to move at high speed, it is not affected by poor stopping accuracy, so that the moving group 2 can accurately reach the target position required for zooming or focusing. Since the position detection device 5 includes a detection part 51 and a sensing part 52, one of the detection part 51 and the sensing part 52 is fixed to the fixed barrel 1, and the other of the detection part 51 and the sensing part 52 is fixed to the moving group 2. During the movement of the moving group 2 relative to the fixed barrel 1, one end of the FPC board is connected to the detection part 51, and the other end of the FPC board is configured to connect to the control device, thus enabling the information detected by the detection part 51 to be fed back in time and receiving control instructions of the control device in time. When the detection part 51 is provided on the moving group 2, the FPC board can adaptively deform as the position of the moving group 2 changes, and the detection part 51 is provided toward the sensing part 52, so that the detection part 51 can be as close as possible to the sensing part 52 to achieve accurate measurement. Since the flexible base material of the FPC board will deform, in order to ensure the flatness of the detection part 51 when it is installed on the FPC board, so that the detection part 51 can be completely attached to the FPC board, the support board 7 is provided on the second side surface 6b of the FPC board. The support board 7 can support the FPC board and ensure the flatness of the FPC board, so as to provide a simple structure and reliable connection method, and ensure that the accuracy of position detection is not affected.

Specifically, when the detection part 51 is provided at the fixed barrel 1, because when assembling the FPC board, it is necessary to make the side of the FPC provided with the printed circuit have a conformation facing the sensing part 52 provided on the moving group 2, so as to facilitate the installation of the detection part 51; and it is also required that the side of the FPC provided a printed circuit has a conformation facing outward, so as to facilitate assembly with other electronic components. These two requirements make the installation form of the FPC have certain particularities.

In this embodiment, the sensing part 52 is provided at the moving group 2, and the detection part 51 is provided at the fixed barrel 1. The FPC board is provided at an outside of the fixed barrel 1, and the FPC board is provided to be bent. The FPC board is provided with a first main body part 61 connected to the fixed barrel 1, and a first folded part 62 folded from the first main body part 61 toward a side of the first main body part 61. A side of the first main body part 61 provided with the printed circuit is provided away from the fixed barrel 1, so as to cause a side of the first folded part 62 provided with the printed circuit to be provided toward the fixed barrel 1. The support board 7 is provided at a side of the first folded part 62 away from the fixed barrel 1, and the detection portion 51 is provided at a side of the first folded part 62 facing the fixed barrel 1.

It can be understood that the fixed barrel 1 is penetrated and provided with a through hole corresponding to the detection part 51, so that the detection part 51 is not limited by the wall thickness of the fixed barrel 1 and can be as close as possible to the sensing part 52. Certainly, the fixed barrel 1 can be assembled from multiple barrel sections, and the detection part 51 can also be provided at the connection gap between the two barrel sections. The specific design can be based on actual conditions, and the embodiments of this specification do not limit this.

By the form of folding nearly 180°, after the FPC board and the fixed barrel 1 are installed and fixed, it is possible to make the side of the first folded part 62 provided with the printed circuit face the side of the fixed barrel 1, thus allowing the side of the first main body part 61 provided with the printed circuit to face the side away from the fixed barrel 1, so as to facilitate connection with other electronic components, such as FPC outlet ports.

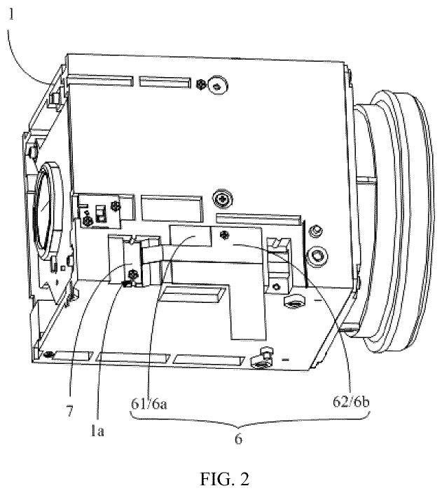

In the first embodiment, referring to FIG. 2 to FIG. 4, the first main body part 61 is connected to the fixed barrel 1, the first folded part 62 is provided to be folded toward a side of the first main body part 61 away from the fixed barrel 1, and the first main body part 61 is at least partially protruded laterally from the first folded part 62, so that when the first folded part 62 is folded and covered at the first side of the first main body part 61, a part of the printed circuit can also be exposed to facilitate connection with external electronic components. At the same time, the first folded part 62 also needs to be provided longer or wider, so that the first folded part 62 is provided to be at least partially protruded from the first main body part 61, thus, when the first main body part 61 covers the first side of the first folded part 62, the first folded part 62 also has part of the printed circuit exposed, so that the detection portion 51 is installed at a zone of the first folded part 62 protruding from the first main body part 61, so as to electrically connect to the exposed printed circuit.

Further, in this embodiment, the width of the first folded part 62 is provided to be equivalent to the size of the support board 7, the fixed barrel 1 is provided with a first connection hole la, both the support board 7 and the first folded part 62 are penetrated and provided with first via holes 7a provided oppositely, and the FPC board and the fixed barrel 1 are fixed by a connecting piece passed through the two first via holes 7a and connected to the first connection hole la. In this way, the first folded part 62 is sandwiched between the fixed barrel 1 and the support board 7. In addition to providing support for the installation of the detection part 51, the support board 7 also provides a larger force-bearing surface for the first folded part 62 to be fixed to the fixed barrel 1, so as to ensure a stable connection of the FPC.

In the second embodiment, referring to FIG. 5 and FIG. 6, the fixed barrel 1 is provided with a first connection hole 1a. The support board 7 is provided to be at least partially protruded laterally from the first folded part 62, A part of the support board 7 protruding from the first folded part 62 is penetrated and provided with a second via hole 7b, and the FPC board and the fixed barrel 1 are fixed by a connecting piece passed through the second via hole 7b and connected to the first connection hole la. In this way, when the size of the first folded part 62 is smaller than the size of the support board 7, through directly using a method of fixing the support board 7 on the fixed barrel 1, it can provide clamping force to the first folded part 62 provided between the fixed barrel 1 and the support board 7, thus preventing that when the FPC board is setting a via hole, the distance between the peripheral edge of the via hole and the peripheral side edge of the FPC board is too small, which exists a risk of being torn off, and at the same time, it also provides installation space for the detection part 51.

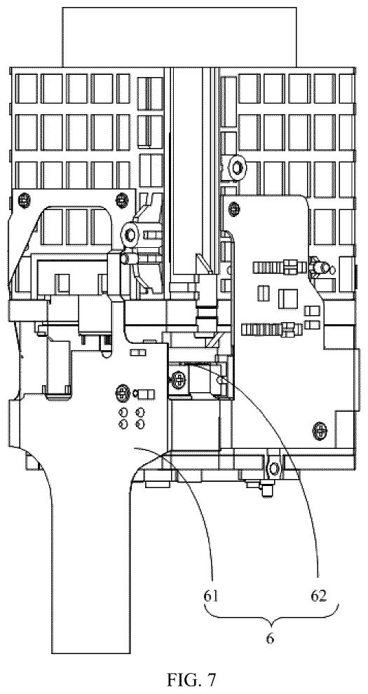

In the third embodiment, referring to FIG. 7 and FIG. 8, the first main body part 61 is provided around a periphery of the fixed barrel 1, and the first folded part 62 is provided to be folded toward a side of the first main body part 61 facing the fixed barrel 1. In this way, it is also possible to realize that a part of the first side of the FPC board faces the outside of the fixed barrel 1, and the other part of the first side of the FPC board faces the inside of the fixed barrel 1. In this way, there is no need to provide the first folded part 62 to be too long or too wide, it can also be achieved the circuit connection requirements of the FPC in different zones towards the fixed barrel 1 and away from the fixed barrel 1.

Further, in this embodiment, the width of the first folded part 62 is provided to be equivalent to the size of the support board 7; the fixed barrel 1 is provided with a first connection hole 1a; both the support board 7 and the first folded part 62 are penetrated and provided with first via holes 7a provided oppositely, and the FPC board and the fixed barrel 1 are fixed by a connecting piece passed through the two first via holes 7a and connected to the first connection hole 1a. Setting in this way, similarly, in addition to providing support for the installation of the detection part 51, the support board 7 also provides a larger force-bearing surface for the first folded part 62 to be fixed to the fixed barrel 1, so as to ensure a stable connection of the FPC.

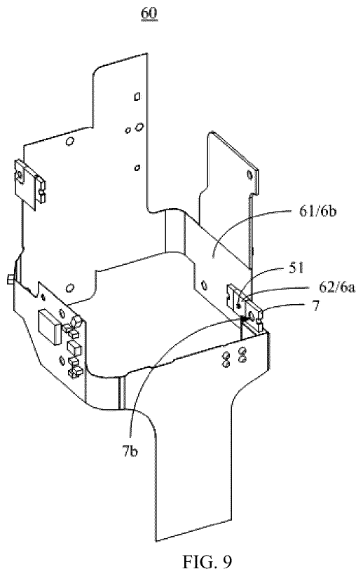

In the fourth embodiment, referring to FIG. 9, the fixed barrel 1 is provided with a first connection hole la, the support board 7 is provided to be at least partially protruded laterally from the first folded part 62, a part of the support board 7 protruding from the first folded part 62 is penetrated and provided with a second via hole 7b, and the FPC board and the fixed barrel 1 are fixed by a connecting piece passed through the second via hole 7b and connected to the first connection hole 1a. Setting in this way, when the size of the first folded part 62 is smaller than the size of the support board 7, the support board 7 provides a clamping force to the first folded part 62, thus avoiding opening holes in the FPC and providing as much installation space as possible for the detection part 51.

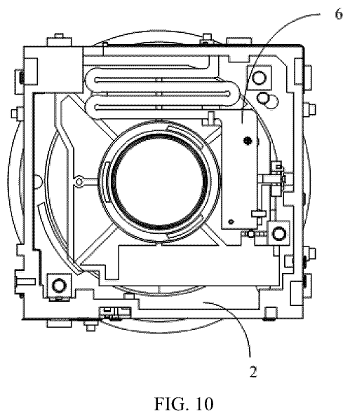

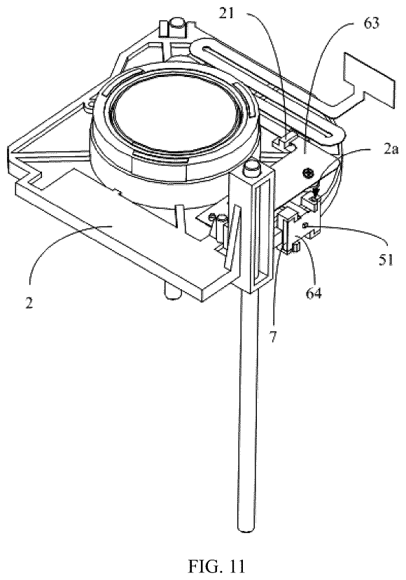

In the fifth embodiment, referring to FIG. 10 to FIG. 13, the detection part 51 is provided at the moving group 2, and the sensing part 52 is provided at the fixed barrel 1. A first side of the FPC board is provided away from the moving group 2, and the detection part 51 is provided toward the sensing part 52. In this way, the side of the FPC board provided with the printed circuit is all facing outward, the detection part 51 can correspond to the sensing part 52 provided in the barrel wall of the fixed barrel 1, so as to achieve accurate detection, at the same time, the first side of the FPC board faces outward, which also facilitates the connection of other electronic components.

Further, since the sensing part 52 corresponds to the peripheral side part of the moving group 2, in order to enable the detection part 51 to be closer to the sensing part 52, in an embodiment, the detection part 51 is provided at the peripheral side of the moving group 2. Thus, in this embodiment, the FPC board includes a second main body part 63 and a second folded part 64 folded from the second main body part 63 toward a side of the second main body part 63, the second main body part 63 is provided at an end surface of the moving group 2, and the second folded part 64 is provided at a periphery of a peripheral side part of the moving group 2. The support board 7 is provided at a side of the second folded part 64 facing the fixed barrel 1, and the detection part 51 is provided at a side of the second folded part 64 away from the fixed barrel 1. In this way, the second main body part 63 can fit with the end surface of the moving group 2, and has a larger installation surface, which facilitates the subsequent setting of the positioning structure and the connection structure. The second folded part 64 is bent close to 90°, so that the second folded part 64 can fit into the peripheral side surface of the moving group 2. At the same time, the detection part 51 is installed on the second folded part 64 to achieve accurate correspondence with the detection part 51.

Further, in order to limit and fix the second folded part 64, in this embodiment, a first slot 2a is provided on the peripheral side part of the moving group 2, and the support board 7 and the second folded part 64 are clamped in the first slot 2a. In this way, limiting the support board 7 and the second folded part 64 simultaneously by the inner wall of the first slot 2a, so as to ensure the stable clamping of the second folded part 64, thus avoiding the defect that the moving group 2 is too thin and is not easy to process when it is fixed by drilling and screwing.

Further, in order to limit and fix the second main body part 63 as well to ensure its stable assembly, in this embodiment, the moving group 2 is further provided with a clamping arm 21 spaced from the end surface of the moving group 2, and a second slot 2b for clamping the second main body part 63 is formed between the clamping arm 21 and the moving group 2. In this way, the side edge of the second main body part 63 can be clamped in the second slot 2b, so as to ensure the further stability of the FPC, and to prevent the FPC from being lifted up and easily interfering with other components during the movement of the moving group 2.

Further, in this embodiment, a positioning column 22 is further protruded from the moving group 2, the second main body part 63 is provided with a positioning hole 63a, and the second main body part 63 is positioned at the moving group 2 by the positioning hole 63a passing through the positioning column 22. Setting in this way, when assembling the second main body part 63, the positioning hole 63a and the positioning column 22 may be used for preliminary positioning firstly to improve the efficiency of later assembly.

Further, due to the relatively large area of the second main body part 63, simply relying on the clamping arm 21 for clamping has a limited operating surface. In order to further stably and fixedly connect the second main body part 63 to the moving group 2, in this embodiment, the moving group 2 is provided with a second connection hole 2c, the second main body part 63 is penetrated and provided with a third via hole 63b, and the FPC board and the moving group 2 are fixed by a connecting piece passed through the third via hole 63b and connected to the second connection hole 2c. It can be understood that the second connection hole 2c can be provided as a threaded hole, and the connecting piece can be provided as a screw connector, in this way, the two can be fixed by screwing. Certainly, the fixing method between the second main body part 63 and the moving group 2 is not limited to the above example. Inspired by the technical essence of the embodiments of this specification, those skilled in the art may also make other changes, but as long as the functions and effects achieved are the same or similar to those of the embodiments of this specification, they shall be covered by the protection scope of the embodiments of this specification.

In one embodiment, the position detection device 5 includes a magnetic grating transducer, the magnetic grating transducer including a magnetic head and a magnetic grid, and the magnetic head forms the detection part 51, the magnetic grid forms the sensing part 52. In this way, the position of the magnetic head can indirectly reflect the position of the moving group 2. By the relative movement between the magnetic head and the magnetic grid, the actual position of the moving group 2 can be accurately detected. It should be noted that the magnetic grid is made by coating a uniform magnetic film on a grid base made of non-magnetic material, and recording magnetic signal grid strips with equal spacing and staggered positive polarity and negative polarity. The magnetic head has two types: dynamic magnetic head (speed response magnetic head) and static magnetic head (flux response magnetic head). The dynamic magnetic head has an output winding, and a signal can be output only when the magnetic head and the magnetic grid move relative to each other. The static magnetic head has two windings, that is, an exciting winding and an output winding, and it can also have signal output when it is relatively stationary with the magnetic grid. The static magnetic head is a multi-gap core with unequal effective cross-sections stacked from iron-nickel alloy sheets. The exciting winding acts like a magnetic switch. When alternating current is applied to the exciting winding, the section of the magnetic circuit with a smaller cross-section of the iron core is excited twice a week to produce magnetic saturation, so that the magnetic lines of force generated by magnetic grid cannot pass through the iron core. Only when the exciting current crosses zero twice a week, the iron core is not saturated, the magnetic lines of force of magnetic grid can pass through the iron core. At this time, the output winding has an induced potential output. Its frequency is twice the frequency of the exciting current, and the amplitude of the output voltage is proportional to the magnetic flux entering the iron core, that is, related to the position of the magnetic head relative to the magnetic grid. The magnetic head is made with multiple gaps in order to increase the output, and its output signal is the average of the signals obtained from multiple gaps, so that the output accuracy can be improved.

In another embodiment, the position detection device 5 includes an optical grating transducer, the optical grating transducer includes a scale grating and an indication grating, the scale grating forms the detection part 51, and the indication grating forms the sensing part 52. In this way, the position of the indication grating can indirectly reflect the position of the moving group 2, and the actual position of the moving group 2 can also be accurately detected by the relative movement between the indication grating and the scale grating.

It should be noted that the optical grating transducer refers to a transducer that uses the grating moiré fringe principle to measure displacement. An optical grating is an optical device composed of a large number of parallel slits of equal width and equal spacing. Commonly used optical gratings are made by engraving a large number of parallel grooves on a glass plate. The notch is the opaque part, and the smooth part between the two notches can transmit light, which is equivalent to a seam. Refined optical gratings have thousands or even tens of thousands of gaps within 1 cm width. This kind of optical grating that utilizes the diffraction of transmitted light is called a transmission grating. The moiré fringes formed by the optical grating have optical amplification effect and average error effect, which can improve measurement accuracy. General optical grating transducer consists of four parts: scale grating, indication grating, optical path system and measurement system. When the scale grating moves relative to the indication grating, it forms light and dark moiré fringes that are roughly sinusoidally distributed. These fringes move at the relative speed of the optical grating and shine directly on the photovoltaic element. A series of electrical pulses is obtained at its output. Digital signal output is generated by amplification, shaping, direction identification and counting systems to directly display the measured displacement.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A zoom lens assembly, comprising:
a fixed barrel extending along a front and rear direction;
a moving group configured for installing lens and movably provided in the fixed barrel along the front and rear direction;
a magnetic drive mechanism configured to drive the moving group to move forward and backward, wherein the magnetic drive mechanism comprises a drive coil and a magnetic body structure; one of the fixed barrel and the moving group is provided with the drive coil, and the other of the fixed barrel and the moving group is provided with the magnetic body structure; the drive coil is provided in a magnetic field where the magnetic body structure is located, and is configured to generate electromagnetic driving force with the magnetic body structure when the drive coil is energized;
a position detection device configured to detect a relative position of the moving group and the fixed barrel in real time, wherein the position detection device comprises a detection part and a sensing part; one of the detection part and the sensing part is fixed to the fixed barrel, and the other of the detection part and the sensing part is fixed to the moving group; and
a circuit board assembly comprising a flexible printed circuit board and a support board, wherein the flexible printed circuit board is provided with a first side surface and a second side surface provided oppositely; the first side surface of the flexible printed circuit board is provided with a printed circuit, and the second side surface of the flexible printed circuit board is provided with the support board; the detection part is provided at a first side of the flexible printed circuit board and a position corresponding to the support board, and the detection part is provided toward the sensing part.

2. The zoom lens assembly according to claim 1, wherein the sensing part is provided at the moving group, and the detection part is provided at the fixed barrel;
the flexible printed circuit board is provided at an outside of the fixed barrel, and the flexible printed circuit board is provided to be bent; the flexible printed circuit board is provided with a first main body part connected to the fixed barrel, and a first folded part folded from the first main body part toward a side of the first main body part; a side of the first main body part provided with the printed circuit is provided away from the fixed barrel, so as to cause a side of the first folded part provided with the printed circuit to be provided toward the fixed barrel; and
the support board is provided at a side of the first folded part away from the fixed barrel, and the detection portion is provided at a side of the first folded part facing the fixed barrel.

3. The zoom lens assembly according to claim 2, wherein the first main body part is connected to the fixed barrel, the first folded part is provided to be folded toward a side of the first main body part away from the fixed barrel, and the first main body part is at least partially protruded laterally from the first folded part; and
the first folded part is provided to be at least partially protruded from the first main body, and the detection portion is provided to be installed at a zone of the first folded part protruding from the first main body part.

4. The zoom lens assembly according to claim 2, wherein the first main body part is provided around a periphery of the fixed barrel, and the first folded part is provided to be folded toward a side of the first main body part facing the fixed barrel.

5. The zoom lens assembly according to claim 2, wherein the fixed barrel is provided with a first connection hole, both the support board and the first folded part are penetrated and provided with first via holes provided oppositely, and the flexible printed circuit board and the fixed barrel are fixed by a connecting piece passed through the two first via holes and connected to the first connection hole.

6. The zoom lens assembly according to claim 2, wherein the fixed barrel is provided with a first connection hole, and the support board is provided to be at least partially protruded laterally from the first folded part; a part of the support board protruding from the first folded part is penetrated and provided with a second via hole, and the flexible printed circuit board and the fixed barrel are fixed by a connecting piece passed through the second via hole and connected to the first connection hole.

7. The zoom lens assembly according to claim 1, wherein the detection part is provided at the moving group, and the sensing part is provided at the fixed barrel; and
a first side of the flexible printed circuit board is provided away from the moving group, and the detection part is provided toward the sensing part.

8. The zoom lens assembly according to claim 7, wherein the flexible printed circuit board comprises a second main body part and a second folded part folded from the second main body part toward a side of the second main body part, the second main body part is provided at an end surface of the moving group, and the second folded part is provided at a periphery of a peripheral side part of the moving group; and
the support board is provided at a side of the second folded part facing the fixed barrel, and the detection part is provided at a side of the second folded part away from the fixed barrel.

9. The zoom lens assembly according to claim 8, wherein a first slot is provided on the peripheral side part of the moving group, and the support board and the second folded part are clamped in the first slot; and/or
the moving group is further provided with a clamping arm spaced from the end surface of the moving group, and a second slot for clamping the second main body part is formed between the clamping arm and the moving group.

10. The zoom lens assembly according to claim 8, wherein a positioning column is further protruded from the moving group, the second main body part is provided with a positioning hole, and the second main body part is positioned at the moving group by the positioning hole passing through the positioning column; and/or
the moving group is provided with a second connection hole, the second main body part is penetrated and provided with a third via hole, and the flexible printed circuit board and the moving group are fixed by a connecting piece passed through the third via hole and connected to the second connection hole.
